(19) United States
(12) Patent Application Publication
(10) Pub. No.: US 2025/0126577 A1
(43) Pub. Date: Apr. 17, 2025

(54) INFORMATION SECURITY PROTECTION METHOD AND APPARATUS

(71) Applicant: HUAWEI TECHNOLOGIES CO., LTD., Shenzhen (CN)

(72) Inventors: Mengyuan LEE, Hangzhou (CN); Guanding YU, Hangzhou (CN); Jian WANG, Hangzhou (CN); Rong LI, Boulogne Billancourt (FR)

(73) Assignee: HUAWEI TECHNOLOGIES CO., LTD., Shenzhen (CN)

(21) Appl. No.: 19/001,879

(22) Filed: Dec. 26, 2024

Related U.S. Application Data
(63) Continuation of application No. PCT/CN2022/103176, filed on Jun. 30, 2022.

(51) Int. Cl. H04W 52/36; H04W 52/22; H04W 52/24

(52) U.S. Cl. CPC H04W 52/367; H04W 52/223; H04W 52/241

(57) ABSTRACT

A first node obtains first power control information (PCI) based on an information security protection requirement, a maximum transmit power of a second node, and channel information between the first and second nodes. The first PCI is a piece of PCI that is obtained through prediction and that maximizes a signal-to-noise ratio of a received signal of the first node when the information security protection requirement is met. The received signal includes a signal from the second node. In addition, the first node sends the first PCI to the second node, where the first PCI is used by the second node to generate a first signal. The first node then receives the first signal from the second node, where the first signal includes data information and security protection information, and the security protection information is used to protect information security of the data information.

### CROSS-REFERENCE TO RELATED APPLICATIONS

This application is a continuation of International Application No. PCT/CN2022/103176, filed on Jun. 30, 2022, the disclosure of which is hereby incorporated by reference in its entirety.

### TECHNICAL FIELD

This disclosure relates to the communication field, and more specifically, to an information security protection method and apparatus.

### BACKGROUND

Currently, wireless communication technologies are widely applied to manufacturing and everyday life, for example, applications in vertical industries with extreme high reliability requirements, such as industrial control, telemedicine, and self-driving, and applications in massive machine-type communications scenarios, such as a smart city, a smart home, and environment monitoring. Further, the wireless communication technology may also be combined with an artificial intelligence (AI) technology, to implement AI tasks such as training and inference of an artificial intelligence model, to meet more diversified requirements.

With the ever widening application of the wireless communication technology, improving information security in wireless communication and reducing the risks of information leakage have become the focus of current research.

### SUMMARY

Embodiments of this disclosure provide an information security protection method and apparatus, to improve communication security and reliability of wireless communication. According to a first aspect, an information security protection method is provided. The method may be performed by a communication device or a module (for example, a chip or a chip system) configured in (or used in) a communication device.

The method includes: A first node obtains first power control information based on an information security protection requirement, a maximum transmit power of a second node, and channel information between the second node and the first node, where the first power control information is power control information that is obtained through prediction and that maximizes a signal-to-noise ratio of a received signal of the first node when the information security protection requirement is met, and the received signal includes a signal from the second node; the first node sends the first power control information to the second node, where the first power control information is used by the second node to generate a first signal; and the first node receives the first signal from the second node, where the first signal includes data information and security protection information, and the security protection information is used to protect information security of the data information.

According to the foregoing solution, the security of the data information transmitted over a wireless channel can be improved, the probability of information leakage can be reduced, and the signal-to-noise ratio of the received signal can be maximized when the security protection requirement of the data information is met, improving the transmission reliability of the data information.

In some embodiments, the first power control information includes power control information corresponding to the data information and power control information corresponding to the security protection information.

According to the foregoing solution, the first power control information may separately include the power control information used to control the data information in the first signal and the power control information used to control the security protection information, so that power control is separately performed on the data information and the security protection information, to maximize the signal-to-noise ratio of the received signal when the security protection requirement of the data information is met, improving the transmission reliability of the data information.

In some embodiments, there are a plurality of second nodes, and that a first node obtains first power control information corresponding to the second node based on an information security budget, a maximum transmit power of a second node, and channel information between the second node and the first node includes: The first node obtains power control information corresponding to each second node based on the information security protection requirement, the maximum transmit power of each second node, and the channel information between the plurality of second nodes and the first node; and that the first node receives the first signal from the second node includes: The first node receives a superimposed signal of first signals from the plurality of second nodes.

According to the foregoing solution, when the first node needs to receive the superimposed signal of the first signals from the plurality of second nodes, the first node obtains the power control information corresponding to each second node based on the information security protection requirement, the maximum transmit power of each second node, and the channel information between the plurality of second nodes and the first node. In this way, when the superimposed signal of the first signals is received by the first node from the plurality of second nodes, the signal-to-noise ratio of the received signal can be maximized when the security protection requirement of the data information is met, improving transmission reliability of the data information.

In some embodiments, the method further includes: the first node sends first information to the second node, where the first information is used to request node feature information output by a k^{th} layer of a first machine learning model, and the data information includes the node feature information that is output by the k^{th} layer of the first machine learning model from the second node; and the method further includes: The first node determines, based on the node feature information output by the k^{th} layer of the first machine learning model, second node feature information corresponding to the k^{th} layer of the first machine learning model.

According to the foregoing solution, when a graph neural network (GNN) is applied to a wireless communication network, node feature information obtained through each layer iteration needs to be transmitted over a wireless channel, and two consecutive communications are highly correlated. Therefore, information transmission security and reliability can be improved by using the foregoing information security protection method.

In some embodiments, the first information includes the first power control information.

In some embodiments, the method further includes: the first node inputs first feature information and the second node feature information corresponding to the k^{th} layer of the first machine learning model into a k^{th} layer of a second machine learning model, to obtain aggregation node feature information output by the k^{th} layer of the second machine learning model, where k is equal to 1, and the first feature information is node feature information of the first node; or k is an integer greater than 1, and the first feature information is second node feature information corresponding to a (k−1)^{th} layer of the first machine learning model.

According to the foregoing solution, the GNN is applied to a wireless communication network, so that each communication node can obtain features and dependencies of its adjacent nodes of different depths in its environment. In this way, a status feature of the communication node is determined, higher-quality communication may be implemented, and distributed control and scheduling of a network may be implemented.

In some embodiments, the method further includes: The first node inputs the second node feature information corresponding to the k^{th} layer into a (k+1)^{th} layer of the first machine learning model, to obtain node feature information output by the (k+1)^{th} layer of the first machine learning model; the first node receives second power control information from the second node; and the first node sends a second signal to the second node, where the second signal includes the node feature information output by the (k+1)^{th} layer of the first machine learning model and security protection information, and the second signal is generated based on the second power control information.

According to the foregoing solution, in addition to obtaining the status feature of the first node by receiving the feature information from each adjacent node, the first node further generates, based on the power control information, the second signal including the node feature information that is output by the (k+1)^{th} layer of the first machine learning model on the first node, so that an adjacent node of the first node can also obtain its own status feature.

According to a second aspect, an information security protection method is provided. The method may be performed by a communication device or a module (for example, a chip or a chip system) configured in (or used in) a communication device.

The method includes: A second node receives first power control information from a first node, where the first power control information is used by the second node to generate a first signal; and the second node sends the first signal to the first node, where the first signal includes data information and security protection information, and the security protection signal is used to protect information security of the data information.

In some embodiments, the first power control information includes power control information corresponding to the data information and power control information corresponding to the security protection information.

In some embodiments, the method further includes: The second node receives first information from the first node, where the first information is used to request node feature information output by a k^{th} layer of a first machine learning model, the data information includes the node feature information that is output by the k^{th} layer of the first machine learning model on the second node, and k is a positive integer.

In some embodiments, the first information includes the first power control information.

In some embodiments, the method further includes: The second node inputs second feature information into the k^{th} layer of the first machine learning model, to obtain the node feature information output by the k^{th} layer of the first machine learning model, where k=1, and the second feature information is node feature information of the second node; or k is an integer greater than 1, the second feature information is first node feature information corresponding to a (k−1)^{th} layer of the first machine learning model, and the first node feature information is determined based on the node feature information that is output by the k^{th} layer of the first machine learning model and that is from at least one first node.

According to a third aspect, a communication apparatus is provided. In a design, the apparatus may include a one-to-one corresponding module for performing the method/operation/step/action described in the first aspect. The module may be a hardware circuit, or may be software, or may be implemented by a hardware circuit in combination with software. In a design, the apparatus includes: a processing unit, configured to obtain first power control information based on an information security protection requirement, a maximum transmit power of a second node, and channel information between the second node and a first node, where the first power control information is power control information that is obtained through prediction and that maximizes a signal-to-noise ratio of a received signal of the first node when the information security protection requirement is met, and the received signal includes a signal from the second node; and a transceiver unit, configured to send the first power control information to the second node, where the first power control information is used by the second node to generate a first signal, where the transceiver unit is further configured to receive the first signal from the second node, where the first signal includes data information and security protection information, and the security protection information is used to protect information security of the data information.

In some embodiments, the first power control information includes power control information corresponding to the data information and power control information corresponding to the security protection information.

In some embodiments, there are a plurality of second nodes, the processing unit is configured to obtain power control information corresponding to each second node based on the information security protection requirement, the maximum transmit power of each second node, and the channel information between the plurality of second nodes and the first node; and the transceiver unit is configured to receive a superimposed signal of first signals from the plurality of second nodes.

In some embodiments, the transceiver unit is further configured to send first information to the second node, where the first information is used to request node feature information output by a k^{th} layer of a first machine learning model, and the data information includes the node feature information that is output by the k^{th} layer of the first machine learning model and that is from the second node.

The processing unit is further configured to determine, based on the node feature information output by the k^{th} layer of the first machine learning model, second node feature information corresponding to the k^{th} layer of the first machine learning model.

In some embodiments, the first information includes the first power control information.

In some embodiments, the processing unit is further configured to input first feature information and the second node feature information corresponding to the k^{th} layer of the first machine learning model into a k^{th} layer of a second machine learning model, to obtain aggregation node feature information output by the k^{th} layer of the second machine learning model, where k is equal to 1, and the first feature information is node feature information of the first node; or k is an integer greater than 1, and the first feature information is second node feature information corresponding to a (k−1)^{th} layer of the first machine learning model.

In some embodiments, the processing unit is further configured to input the second node feature information corresponding to the k^{th} layer into a (k+1)^{th} layer of the first machine learning model, to obtain node feature information output by the (k+1)^{th} layer of the first machine learning model; the transceiver unit is further configured to receive second power control information from the second node; and the transceiver unit is further configured to send a second signal to the second node, where the second signal includes the node feature information output by the (k+1)^{th} layer of the first machine learning model and security protection information, and the second signal is generated based on the second power control information.

According to a fourth aspect, a communication apparatus is provided. In a design, the apparatus may include a one-to-one corresponding module for performing the method/operation/step/action described in the second aspect. The module may be a hardware circuit, or may be software, or may be implemented by a hardware circuit in combination with software. In a design, the apparatus includes: a transceiver unit, configured to receive first power control information from a first node; and a processing unit, configured to generate a first signal based on the first power control information, where the transceiver unit is further configured to send the first signal to the first node, where the first signal includes data information and security protection information, and the security protection signal is used to protect information security of the data information.

In some embodiments, the first power control information includes power control information corresponding to the data information and power control information corresponding to the security protection information.

In some embodiments, the transceiver unit is further configured to receive first information from the first node, where the first information is used to request node feature information output by a k^{th} layer of a first machine learning model, the data information includes the node feature information that is output by the k^{th} layer of the first machine learning model on the second node, and k is a positive integer.

In some embodiments, the first information includes the first power control information.

In some embodiments, the processing unit is further configured to input second feature information into the k^{th} layer of the first machine learning model, to obtain the node feature information output by the k^{th} layer of the first machine learning model, where k=1, and the second feature information is node feature information of the second node; or k is an integer greater than 1, the second feature information is first node feature information corresponding to a (k−1)^{th} layer of the first machine learning model, and the first node feature information is determined based on the node feature information that is output by the k^{th} layer of the first machine learning model and that is from at least one first node.

According to a fifth aspect, a communication apparatus is provided, including a processor. The processor may implement the method according to the first aspect or the second aspect and any one of the embodiments of the first aspect or the second aspect. Optionally, the communication apparatus further includes a memory. The processor is coupled to the memory, and may be configured to execute instructions in the memory, to implement the method according to the first aspect or the second aspect and any one of the embodiments of the first aspect or the second aspect. Optionally, the communication apparatus further includes a communication interface, and the processor is coupled to the communication interface. In embodiments of this disclosure, the communication interface may be a transceiver, a pin, a circuit, a bus, a module, or another type of communication interface. This is not limited.

In some embodiments, the communication apparatus is a communication device. When the communication apparatus is the communication device, the communication interface may be a transceiver or an input/output interface.

In some embodiments, the communication apparatus is a chip or a chip system configured in a communication device. When the communication apparatus is the chip or the chip system configured in the communication device, the communication interface may be an input/output interface.

Optionally, the transceiver may be a transceiver circuit. Optionally, the input/output interface may be an input/output circuit.

According to a sixth aspect, a processor is provided. The processor includes an input circuit, an output circuit, and a processing circuit. The processing circuit is configured to: receive a signal through the input circuit, and transmit a signal through the output circuit, to enable the processor to perform the method according to the first aspect or the second aspect and any one of the embodiments of the first aspect or the second aspect.

In some embodiments, the processor may be one or more chips, the input circuit may be an input pin, the output circuit may be an output pin, and the processing circuit may be a transistor, a gate circuit, a trigger, any logic circuit, or the like. An input signal received by the input circuit may be received and input by, for example, but not limited to, a receiver, a signal output by the output circuit may be output to, for example, but not limited to, a transmitter and transmitted by the transmitter, and the input circuit and the output circuit may be a same circuit, where the circuit is used as the input circuit and the output circuit at different moments. Specific implementations of the processor and the various circuits are not limited in embodiments of this disclosure.

According to a seventh aspect, a computer program product is provided. The computer program product includes a computer program (which may also be referred to as code or instructions). When the computer program is run, a computer is enabled to perform the method according to the first aspect or the second aspect and any one of the embodiments of the first aspect or the second aspect.

According to an eighth aspect, a computer-readable storage medium is provided. The computer-readable storage medium stores a computer program (which may also be referred to as code or instructions). When the computer program is run on a computer, the computer is enabled to perform the method according to the first aspect or the second aspect and any one of the embodiments of the first aspect or the second aspect.

According to a ninth aspect, a communication system is provided, including the foregoing at least one first node and at least one second node.

It should be noted that, the first node or the second node may be a communication device, or may be a module (such as a chip or a chip system) configured in (or used in) a communication device.

### BRIEF DESCRIPTION OF DRAWINGS

FIG. 1 is a diagram of a communication system according to an embodiment of this disclosure;

FIG. 2 is a schematic flowchart of graph neural network inference according to an embodiment of this disclosure;

FIG. 3 is a schematic flowchart of an information security protection method according to an embodiment of this disclosure;

FIG. 4 is another schematic flowchart of an information security protection method according to an embodiment of this disclosure;

FIG. 5 is a diagram of a structure of a communication apparatus according to an embodiment of this disclosure; and

FIG. 6 is another diagram of a structure of a communication apparatus according to an embodiment of this disclosure.

### DESCRIPTION OF EMBODIMENTS

The following describes technical solutions of this disclosure with reference to accompanying drawings.

In embodiments of this application, “/” may indicate an “or” relationship between associated objects, for example, A/B may indicate A or B; and “and/or” may indicate that three relationships exist between the associated objects, for example, A and/or B may indicate the following three cases: A exists alone, both A and B exist, and B exists alone, where A and B may be singular or plural. For ease of describing the technical solutions in embodiments of this application, terms such as “first” and “second” may be used for differentiation in embodiments of this application. The words such as “first” and “second” do not limit a quantity and an execution sequence, and the words such as “first” and “second” do not limit a definite difference. In embodiments of this application, the word such as “example” or “for example” is used to represent an example, evidence, or descriptions. Any embodiment or design solution described as “example” or “for example” should not be explained as being better or having more advantages than another embodiment or design solution. The word such as “example” or “for example” is used to present a related concept in a specific manner for ease of understanding. In embodiments of this application, “at least one (type)” may alternatively be described as “one (type) or more (types)”, and “a plurality of (types)” may be two (types), three (types), four (types), or more (types). This is not limited in this application.

The technical solutions in embodiments of this application may be applied to various communication systems, for example, a long-term evolution (LTE) system, an LTE frequency division duplex (FDD) system, an LTE time division duplex (TDD) system, a 5th generation (5G) communication system, and a wireless fidelity (Wi-Fi) system. In addition, a communication method provided in this application may be further applied to a communication system evolved after 5G, for example, a 6th generation (6G) communication system, a future communication system, another communication system, or the like. This is not limited in this application.

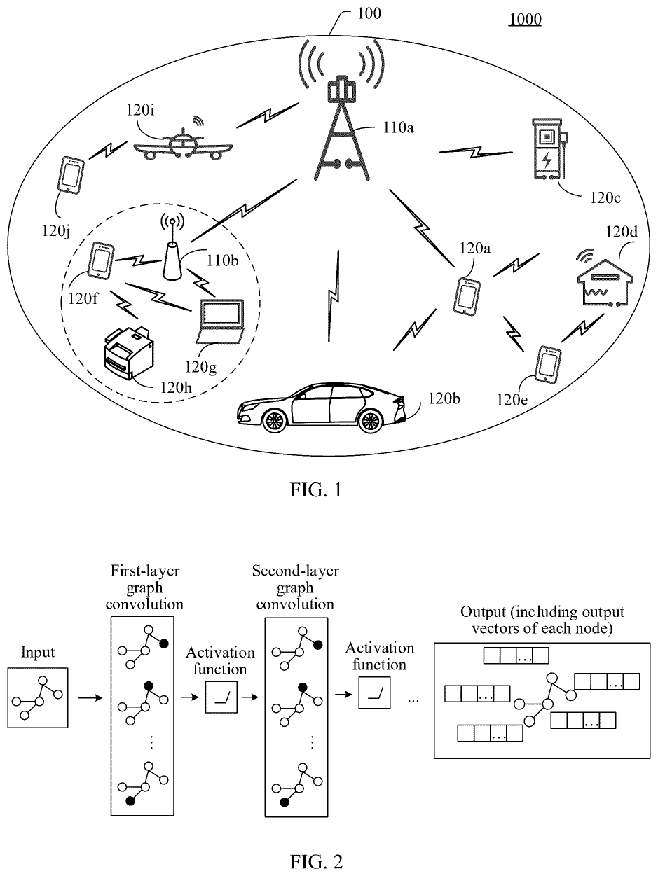

FIG. 1 is a diagram of an architecture of a communication system 1000 to which this application is applicable. As shown in FIG. 1, the communication system includes a radio access network (RAN) 100. The radio access network 100 may include at least one access network device (for example, 110a and 110b in FIG. 1), and may further include at least one terminal (for example, 120a to 120j in FIG. 1). The terminal and the access network device, and the terminal and the terminal may be connected to each other in a wireless manner. FIG. 1 is merely a diagram. The communication system may further include another communication device.

The communication node in embodiments of this application, for example, a first node and/or a second node, may be an access network device. For example, the access network device may be a base station, a NodeB, an evolved NodeB (eNodeB or eNB), a transmission reception point (TRP), a next generation NodeB (gNB) in a 5th generation (5G) mobile communication system, an access network device in an open radio access network (O-RAN or open RAN), a next generation base station in a 6th generation (6G) mobile communication system, a base station in a future mobile communication system, an access node in a wireless fidelity (Wi-Fi) system, or the like. The access network device may be a macro base station (for example, 110a in FIG. 1), or may be a micro base station or an indoor base station (for example, 110b in FIG. 1), or may be a relay node, a donor node, or the like. A specific technology and a specific device form that are used by the access network device are not limited in this application.

The communication node in embodiments of this application, for example, a first node and/or a second node, may be a terminal device, and the terminal device may also be referred to as a terminal, user equipment (UE), a mobile station, a mobile terminal, or the like. The terminal may be widely used in various scenarios for communication. For example, the scenario includes but is not limited to at least one of the following scenarios: enhanced mobile broadband (eMBB), ultra-reliable low-latency communication (URLLC), massive machine-type communication (mMTC), device-to-device (D2D) communication, vehicle to everything (V2X) communication, machine-type communication (MTC), an internet of things (IoT), virtual reality, augmented reality, industrial control, self-driving, telemedicine, a smart grid, smart furniture, smart office, smart wearable, smart transportation, a smart city, or the like. The terminal may be a mobile phone, a tablet computer, a computer with a wireless transceiver function, a wearable device, a vehicle, an uncrewed aerial vehicle, a helicopter, an airplane, a ship, a robot, a robotic arm, a smart home device, or the like.

A specific technology and a specific device form that are used by the communication node provided in embodiments are not limited in this application.

The following describes related technologies and terms in embodiments of this application.

### 1. Graph Neural Network GNN

A conventional AI technology has superior performance in extracting features of Euclidean spatial data. However, in actual application scenarios, a lot of data does not belong to Euclidean space. Therefore, a graph neural network for processing graph data emerges. A graph data structure includes nodes and edges. The GNN is a connection model. A dependency relationship in a graph is obtained by transmitting information between nodes in the network. High-dimensional graph data can be mapped to low-dimensional vector space. The GNN updates a status of a node by using an adjacent node of any depth from the node. If two nodes are communicatively reachable, the two nodes may be referred to as adjacent nodes. For example, if a node A may receive a signal from a node B, and the node B may receive the signal sent by the node A, the node A and the node B are communicatively reachable, and the node A and the node B are adjacent nodes. The GNN still retains a hierarchical structure, and an operation at a k^{th} layer of the GNN may be represented as follows:

$${q}_{v}^{( k )} = {\sum }_{u ∈ N ( v )} {f}_{t}^{( k )} ( \{ {q}_{u}^{( k - 1 )} , {e}_{uv} \} ) ,$$

$$and$$

$${o}_{v}^{( k )} = {f}_{o}^{( k )} ( {q}_{v}^{( k - 1 )} , {q}_{v}^{( k )} ) ,$$

where
k is an integer greater than or equal to 1, qᵥ^{(k)} is an intermediate result of a node v at the k^{th} layer of the GNN, eᵤᵥ is a feature of an edge of the node v and a node u, N(v) is a set of identifiers of adjacent nodes of the node v, and oᵥ^{(k)} is an output result of the node v at the k^{th} layer of the GNN. ƒₜ^{(k)} and ƒₒ^{(k)} may be functions that are commonly used to implement a neural network by using a multi-layer perceptron (MLP), but this application is not limited thereto. When k=1, that is, k−1=0, qᵥ⁽⁰⁾ is a node feature xᵥ of the node v, and qᵤ⁽⁰⁾ is a node feature xᵤ of the node u. In other words, in an operation at a first layer of the GNN, qᵤ⁽⁰⁾ is a node feature xᵤ of the node u, and an intermediate result qᵥ⁽¹⁾ of the first layer may be represented as:

$${q}_{v}^{( 1 )} = {\sum }_{u ∈ N ( v )} {f}_{t}^{( 1 )} ( \{ {q}_{u}^{( 0 )} , {e}_{uv} \} ) = {\sum }_{u ∈ N ( v )} {f}_{t}^{( 1 )} ( \{ {x}_{u} , {e}_{uv} \} ) ,$$

and
qᵥ⁽⁰⁾ is a node feature xᵥ of the node v, and an output result oᵥ⁽¹⁾ of the first layer may be represented as:

$${o}_{v}^{( 1 )} = {f}_{o}^{( 1 )} ( {q}_{v}^{( 0 )} , {q}_{v}^{( 1 )} ) = {f}_{o}^{( 1 )} ( {x}_{v} , {q}_{v}^{( 1 )} ) .$$

When k is greater than 1, that is, in operations at a second layer and a subsequent layer of the GNN, an intermediate result qᵤ^{(k-1)} of a (k−1)^{th} layer of each adjacent node and a feature eᵤᵥ of an edge of the node u and the node v are used as an input of ƒₜ^{(k)}, to obtain a sum of outputs of ƒₜ^{(k)} corresponding to each adjacent node, that is, the intermediate result qᵥ^{(k)} of the k^{th} layer of the node v. Then, the intermediate result qᵥ^{(k)} and the intermediate, result qᵥ^{(k-1)} obtained at the previous layer (that is, the (k−1)^{th} layer) are used as an input of ƒₒ^{(k)}, to obtain an output result oᵤ^{(k)} that is of the k^{th} layer of the node v and that is output by ƒₒ^{(k)}. By using a multi-layer convolution operation, a node can continuously aggregate information of adjacent nodes based on a topology structure, and update a status of the node.

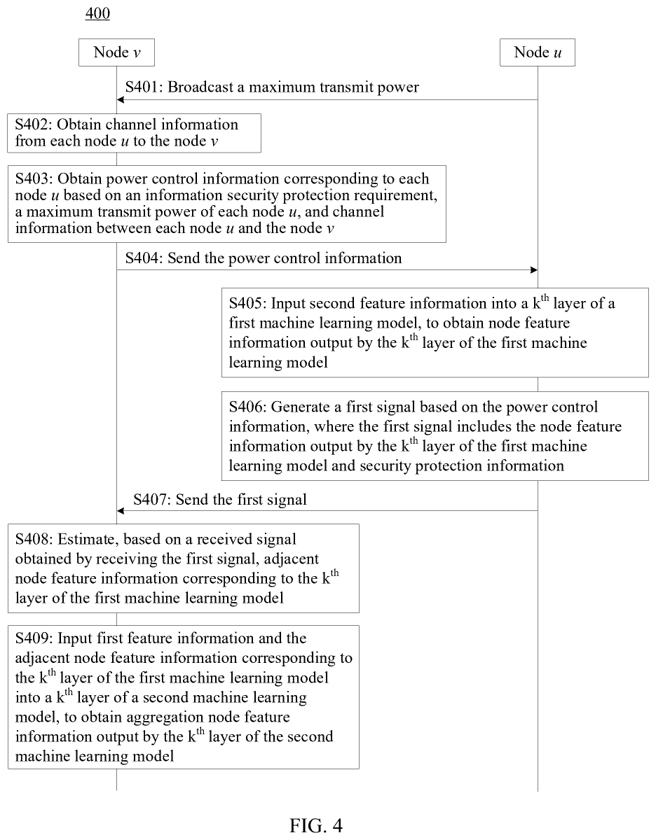

For example, as shown in FIG. 2, after graph data is input into a GNN, the GNN performs a first-layer graph convolution. For each node, a node feature qᵤ⁽⁰⁾=xᵤ of each adjacent node u and a feature eᵤᵥ of an edge of a node v and a node u, where u∈N(v), are input into a function ƒₜ⁽¹⁾, to obtain an intermediate result qᵥ⁽¹⁾ of the node v at a first layer of the GNN, and then the intermediate result qᵥ⁽¹⁾ and a node feature qᵥ⁽⁰⁾=xᵥ of the node v are input into a function ƒₒ⁽¹⁾, to obtain an output result oᵥ⁽¹⁾ of the node v at the first layer of the GNN. A first-layer result is mapped to a second-layer graph convolution by using an activation function, and the second-layer graph convolution of the GNN is performed. In the second-layer graph convolution, an intermediate result qᵥ⁽²⁾ at the second layer is obtained based on the intermediate result qᵤ⁽¹⁾ obtained at the first layer of each adjacent node u and the feature eᵤᵥ of the edge of the node v and the node u, and then the output result oᵥ⁽²⁾ of the node v at the first layer of the GNN is obtained based on the intermediate result qᵥ⁽²⁾ at the second layer and the intermediate result qᵥ⁽¹⁾ of the node v obtained at the first layer. After K times of iterations are performed in this manner, an output result of the GNN is obtained through inference, so that aggregation information of adjacent nodes based on the topology structure can be obtained, and a status of each node can be determined. The output result includes an output vector of each node, and each output vector includes an output result of a K^{th} layer corresponding to one node. In the embodiment shown in FIG. 4 of this application, the GNN is applied to a wireless communication network. To improve security and reliability of transmitting each layer iteration result of the GNN over a wireless channel, reference may be made to an information security protection method provided in this application. For details, refer to descriptions in the following embodiment shown in FIG. 4.

### 2. Local Differential Privacy (LDP) Technology

The LDP technology protects security of data information by adding noise to the data information, to reduce correlation of the data information. Even if an attacker obtains a piece of data information, the attacker cannot infer other data information.

It is assumed that an information security budget is ε, M is a random function that uses a data set as an input, and S is a set of outputs of the random function M, any two adjacent data sets Q and Q′ are used as inputs of the random function M, and probabilities that the outputs are in the set S are respectively Pr(M(Q)∈S) and Pr(M(Q′)∈S). If the following inequality is met:

$$Pr ( M ( Q ) ∈ S ) \leq {e}^{ε} Pr ( M ( {Q}^{′} ) ∈ S ) + δ .$$

M satisfies (ε,δ)−LDP. ε and δ are positive real numbers, and the information security budget ε is used to control a similarity between the foregoing two probabilities. A smaller value of & indicates better information security protection performance, that is, a lower probability that the attacker determines whether the input is Q or Q′ based on the outputs of the random function M. δ is used to describe a probability of violating the foregoing information security protection requirement. A smaller value of δ indicates a lower probability of allowing violation of the information security protection requirement and better information security protection performance. A manner of adding Gaussian noise to the data information is an important means of implementing (ε,δ)−LDP, and this manner may alternatively be referred to as a Gaussian mechanism.

To improve information security in wireless communication and reduce a risk of information leakage, embodiments of this application proposes that information security protection is implemented by adding Gaussian noise to data information at a transmit end. However, during wireless communication, a channel has channel fading impact on a transmitted signal and noise exists on the channel. To avoid a problem that a signal cannot be correctly received by a receive end due to noise increased by data information security improvement, this application further proposes that power control information of a signal may be determined based on an information security requirement, a maximum transmit power of a transmit end, and channel information, so that the signal sent by the transmit end can be accurately received by the receive end when the security protection requirement of the data information is met. In this way, transmission reliability of the data information can be improved.

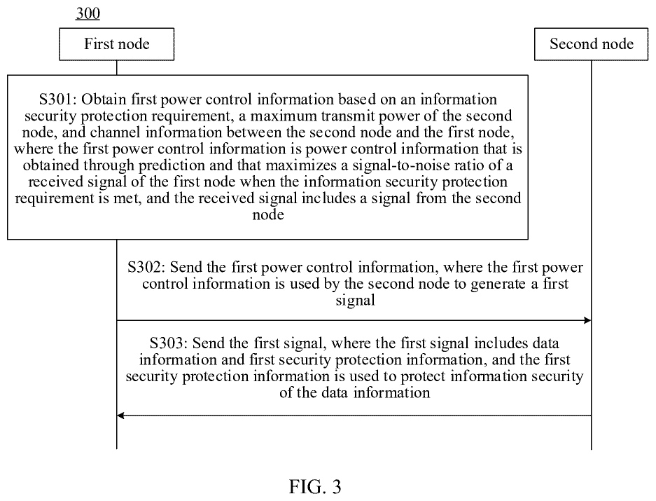

FIG. 3 is a schematic flowchart of an information security protection method according to an embodiment of this application.

S301: A first node obtains first power control information based on an information security protection requirement, a maximum transmit power of a second node, and channel information between the second node and the first node, where the first power control information is power control information that is obtained through prediction and that maximizes a signal-to-noise ratio (SNR) of a received signal of the first node when the information security protection requirement is met, and the received signal includes a signal from the second node.

The first node may obtain the maximum transmit power of the second node from the second node. In addition, the first node may perform channel measurement to obtain the channel information between the second node and the first node.

The information security protection requirement may be referred to as an information security budget, and is a requirement of a communication node for an information security degree during information transmission. The first node may determine, by using an information security threshold corresponding to the security protection requirement, whether the information security degree of the received signal meets the information security protection requirement. For example, the first node obtains, through prediction based on the information security threshold that meets the information security protection requirement, the maximum transmit power of the second node, and the channel information, the first power control information that maximizes the SNR of the received signal of the first node when the information security protection requirement is met.

The following describes how the first node obtains the first power control information through prediction.

To improve information security, the second node needs to superimpose security protection information mᵤᵥ on data information wᵤᵥ to be sent to the first node, where u is an identifier of the second node, v is an identifier of the first node, and the security protection information mᵤᵥ may be white Gaussian noise. However, this is not limited in this application. The first node may determine a power control parameter based on the channel information, so that a transmit power of a to-be-sent signal (where the signal includes data information and security protection information) generated by the second node based on the power control parameter falls within a maximum transmit power range of the second node, and the power control parameter can maximize the SNR of the received signal received by the first node after the signal is transmitted through a channel.

In Implementation 1, the received signal is a signal from the second node.

In an example, pre-equalization processing may be performed on a signal at the second node (that is, a signal transmit end). The pre-equalization processing may alternatively be referred to as precoding, to equalize channel interference on the signal. For example, the to-be-sent signal \tilde{w}ᵤᵥ of the second node may be represented as:

$${\tilde{w}}_{uv} = \text{?} ( \frac{\sqrt{{α}_{uv} {P}_{u}}}{L} {w}_{uv} + \sqrt{{β}_{uv} {P}_{u}} {m}_{uv} ) .$$

$$\text{?} \text{indicates text missing or illegible when filed}$$

L is a norm upper limit ∥\tilde{w}ᵤᵥ∥₂≤L of the data information. To be specific, after the second node processes the data information and the security protection information based on the power control parameter, a power coefficient of the data information wᵤᵥ in the generated signal is \sqrt{αᵤᵥPᵤ}, where αᵤᵥ is a power control parameter of the data information, and Pᵤ is the maximum transmit power of the second node; and a power coefficient of the security protection information mᵤᵥ is βᵤᵥPᵤ, where βᵤᵥ is a power control parameter of the security protection information. In addition, the second node may pre-equalize the signal by using an equalization coefficient e^{-jϕ}^{ᵤᵥ}.

In another example, equalization processing may be performed on a signal after the signal is received by the first node (that is, a signal receive end). For example, the to-be-sent signal \tilde{w}ᵤᵥ of the second node may be represented as:

$${\tilde{w}}_{uv} = \frac{\sqrt{{α}_{uv} {P}_{u}}}{L} {w}_{uv} + \sqrt{{β}_{uv} {P}_{u}} {m}_{uv} .$$

In this implementation, for example, the received signal received by the first node from the second node may be represented as:

$${R}_{uv} = {h}_{uv} {\tilde{w}}_{uv} + {n}_{uv} .$$

hᵤᵥ represents a weighting coefficient of a channel between the first node and the second node, and nᵤᵥ represents channel noise.

To enable the first node to obtain wᵤᵥ through unbiased estimation from Rᵤᵥ, and the signal obtained by superimposing the security protection information mᵤᵥ meets the information security protection requirement of the first node, the power control parameters αᵤᵥ and βᵤᵥ need to meet the following constraint conditions:

$$\{ \begin{matrix}0 < \text{?} \leq 1 , 0 \leq {β}_{uv} \leq 1 - {α}_{uv} \\ \frac{2 \vert {h}_{uv} \vert \sqrt{\text{?} {P}_{u}}}{\sqrt{{\vert {h}_{uv} \vert}^{2} {β}_{uv} {P}_{u} + {σ}_{v}^{2}}} \sqrt{2 ln \frac{1.25}{δ}} \leq {ε}_{v}\end{matrix} .$$

$$\text{?} \text{indicates text missing or illegible when filed}$$

εᵥ is the information security threshold corresponding to the information security protection requirement of the first node, δ is a probability that the information security protection requirement is not met, and σᵥ² is a channel noise power.

To maximize the SNR of the received signal Rᵤᵥ, it may be obtained that the power control parameter αᵤᵥ that meets the foregoing constraint condition meets the following formula:

$${α}_{uv} = \{ \begin{matrix}\frac{{ε}_{v}^{2} ( {σ}_{v}^{2} + {\vert {h}_{uv} \vert}^{2} {P}_{u} )}{{\vert {h}_{uv} \vert}^{2} {P}_{u} ( 8 ln \frac{1.25}{δ} + {ε}_{v}^{2} )} & , {ε}_{v} \leq {ε}_{uv}^{th 1} \\ 1 & , {ε}_{v} > {ε}_{uv}^{th 1}\end{matrix} \qquad Formula ( 1 )$$

$${ε}_{uv}^{th 1} = \sqrt{\frac{8 ln \frac{1.25}{δ} {\vert {h}_{uv} \vert}^{2} {P}_{u}}{{σ}_{v}^{2}}} ,$$

and εᵤᵥ^{th1} is a threshold of a value range of εᵥ. As shown in Formula (1), if

$${ε}_{v} \leq {ε}_{uv}^{th 1} ,$$

$${α}_{uv} = \frac{{ε}_{v}^{2} ( {σ}_{v}^{2} + {\vert {h}_{uv} \vert}^{2} {P}_{u} )}{{\vert {h}_{uv} \vert}^{2} {P}_{u} ( 8 ln \frac{1.25}{δ} + {ε}_{v}^{2} )} ;$$

$$or if$$

$${ε}_{v} > {ε}_{uv}^{th 1} ,$$

$${α}_{uv} = 1.$$

In addition, it may be obtained that the power control parameter βᵤᵥ that meets the foregoing constraint condition meets the following formula:

$${β}_{uv} = 1 - {α}_{uv} \qquad Formula ( 2 )$$

Therefore, the first node may obtain the power control parameter a, and the power control parameter βᵤᵥ based on the information security threshold εᵥ, the maximum transmit power Pᵤ of the second node, and the channel information between the first node and the second node (for example, including the channel weighting coefficient hᵤᵥ and/or the channel noise power σᵥ² that are/is between the first node and the second node and that are/is obtained by the first node by performing channel measurement). The first node may send the first power control information to the second node, where the first power control information indicates the power control parameter αᵤᵥ and the power control parameter βᵤᵥ. It may be understood that, the “indication” in this application includes a direct indication, an indirect indication, an explicit indication, and an implicit indication.

In an example, the first power control information may indicate the power control parameter αᵤᵥ and the power control parameter βᵤᵥ. Alternatively, the first power control information may indicate one of the two power control parameters, and the second node may determine the other power control parameter based on the one power control parameter and a relationship between αᵤᵥ and βᵤᵥ (that is, a sum of the two power control parameters is 1).

In another example, the first power control information may indicate a ratio of αᵤᵥ to βᵤᵥ, and the second node may determine two power control parameters based on a relationship between αᵤᵥ and βᵤᵥ.

In still another example, the first power control information indicates an identifier of a power control parameter. For example, the first node determines, based on the power control parameter, an identifier corresponding to the power control parameter in a predefined power control parameter set. For example, the predefined power control parameter set includes a plurality of power control parameters and an identifier of each power control parameter. The first node sends, to the second node, the first power control information that indicates the identifier corresponding to the power control parameter, and the second node determines, based on the identifier of the power control parameter indicated by the first power control information, the power control parameter corresponding to the identifier in the predefined power control parameter set. The first power control information may indicate an identifier corresponding to one power control parameter in αᵤᵥ and βᵤᵥ, and the second node determines the other power control parameter based on the relationship between αᵤᵥ and βᵤᵥ. Alternatively, the first power control information may indicate identifiers of the two power control parameters, and the second node determines the two power control parameters based on the identifiers.

In Implementation 2, there are a plurality of second nodes, and a received signal of the first node is a superimposed signal of signals from the plurality of second nodes. The first node obtains power control information corresponding to each second node based on the information security threshold, the maximum transmit power of each second node, and the channel information between the plurality of second nodes and the first node.

In other words, the plurality of second nodes may send the signals to the first node, and the signals of the plurality of second nodes are superimposed on the channel, and the received signal of the first node is a superimposed signal of the signals from the plurality of second nodes.

The plurality of second nodes may perform pre-equalization processing on a signal, so that the first node may restore data information based on the superimposed signal. A to-be-sent signal of each second node may be represented as \tilde{w}ᵤᵥ obtained through the pre-equalization processing. For example, there are N second nodes, identifiers of the N second nodes are respectively 1 to N, and N is an integer greater than 1. A to-be-sent signal of the second node (denoted as a second node 1) whose identifier is 1 may be represented as:

$$\text{?} - \frac{\sqrt{\text{?}}}{L} \text{?} + \sqrt{\text{?}} \text{?} .$$

$$\text{?} \text{indicates text missing or illegible when filed}$$

P₁ is a maximum transmit power of the second node 1, w₁ᵥ represents data information of the second node 1, m₁ᵥ represents security protection information of the second node 1, α₁ᵥ represents a power control parameter of the data information of the second node 1, and βᵤᵥ is a power control parameter of the data information of the second node 1. For a to-be-sent signal of a second node with another identifier, refer to the foregoing representation manner of the to-be-sent signal of the second node 1. For brevity, details are not described herein again.

The plurality of second nodes send the to-be-sent signals of the plurality of second nodes to the first node, and the to-be-sent signals of the plurality of second nodes are superimposed on a channel, so that a received signal received by the first node is Rᵥ, that is, a superimposed signal of the signals from the plurality of second nodes, which may be represented as follows:

$${R}_{v} = \text{?} ( {h}_{uv} \text{?} + {n}_{uv} ) = \text{?} \vert {h}_{uv} \vert \frac{\sqrt{{α}_{uv} {P}_{u}}}{L} \text{?} + \text{?} \vert {h}_{uv} \vert \sqrt{{β}_{uv} {P}_{u}} \text{?} + {n}_{v} .$$

$$\text{?} \text{indicates text missing or illegible when filed}$$

$${n}_{v} = {\sum }_{u ∈ N ( v )} {n}_{uv} ,$$

and N(v) is a set of identifiers of the second nodes. For example, there are N second nodes, and a set of identifiers of the second nodes includes N identifiers corresponding to the N second nodes. For example, if the identifiers of the N second nodes are respectively 1 to N, the received signal may be represented as:

$${R}_{v} = \text{?} ( {h}_{uv} \text{?} + {n}_{uv} ) = ( {h}_{1 v} \text{?} + {n}_{1 v} ) + ( {h}_{2 v} \text{?} + {n}_{2 v} ) + … + ( {h}_{Nv} \text{?} + {n}_{Nv} ) = \text{?} \vert {h}_{uv} \vert \frac{\sqrt{{α}_{uv} {P}_{u}}}{L} {w}_{uv} + \text{?} \vert {h}_{uv} \vert \sqrt{{β}_{uv} {P}_{u}} {m}_{uv} + {n}_{v} ,$$

$$where$$

$$\text{?} \text{indicates text missing or illegible when filed}$$

h₁ᵥ is channel information between the second node whose identifier is 1 and the first node, h₂ᵥ is channel information between the second node whose identifier is 2 and the first node, and h_{Nv} is channel information between the second node whose identifier is N and the first node.

The SNR of the received signal Rᵥ may be represented as follows:

$${ρ}_{v} = \frac{{\sum }_{u ∈ N ( v )} {\vert {h}_{uv} \vert}^{2} {α}_{uv} {P}_{u}}{{\sum }_{u ∈ N ( v )} {\vert {h}_{uv} \vert}^{2} {β}_{uv} {P}_{u} + {σ}_{v}^{2}} .$$

To enable the first node to obtain wᵥ through unbiased estimation from Rᵥ, the data information

$${w}_{v} = {\sum }_{u ∈ N ( v )} {w}_{uv}$$

or average value information

$${w}_{v} = E ( {\sum }_{u ∈ N ( v )} {w}_{uv} )$$

of the data information of the plurality of second nodes is superimposed, and Rᵥ meets the information security protection requirement of the first node, and αᵤᵥ and βᵤᵥ need to meet the following constraint condition:

$$\{ \begin{matrix}0 < {α}_{uv} \leq 1 , 0 < {β}_{uv} \leq 1 - {α}_{uv} \\ \vert {h}_{uv} \vert \frac{\sqrt{{α}_{uv} {P}_{u}}}{L} \hat{=} {C}_{v} \\ \frac{2 {C}_{v} L}{\sqrt{{\sum }_{u ∈ N ( v )} {\vert {h}_{uv} \vert}^{2} {β}_{uv} {P}_{u} + {σ}^{2}}} \sqrt{2 ln \frac{1.25}{δ}} \leq {ε}_{v}\end{matrix} , where$$

$$\vert {h}_{uv} \vert \frac{\sqrt{{α}_{uv} {P}_{u}}}{L} \hat{=} {C}_{v}$$

represents that

$$\vert {h}_{uv} \vert \frac{\sqrt{{α}_{uv} {P}_{u}}}{L}$$

is defined as Cᵥ, or in other words, represents that

$$\vert {h}_{uv} \vert \frac{\sqrt{{α}_{uv} {P}_{u}}}{L}$$

is represented by Cᵥ, and Cᵥ in an expression including Cᵥ may be replaced with

$$\vert {h}_{uv} \vert \frac{\sqrt{{α}_{uv} {P}_{u}}}{L} .$$

εᵥ is an information security threshold corresponding to the information security protection requirement of the first node, and σᵥ² is a channel noise power.

To maximize the SNR of the received signal Rᵤᵥ, it may be obtained that the power control parameter αᵤᵥ that meets the foregoing constraint condition meets the following formula:

$${α}_{uv} = \{ \begin{matrix}\frac{{ε}_{v}^{2} ( {σ}_{v}^{2} + {\sum }_{u ∈ N ( v )} {\vert {h}_{uv} \vert}^{2} {P}_{u} )}{{\vert {h}_{uv} \vert}^{2} {P}_{u} ( 8 ln \frac{1.25}{δ} + \vert N \vert {ε}_{v}^{2} )} , & {ε}_{v} \leq {ε}_{uv}^{th 2} \\ \frac{{min}_{u ∈ N ( v )} {\vert {h}_{uv} \vert}^{2} {P}_{u}}{{\vert {h}_{uv} \vert}^{2} {P}_{u}} , & {ε}_{v} > {ε}_{uv}^{th 2}\end{matrix} \qquad Formula ( 3 )$$

N is a quantity of second nodes in a set N(v), εᵤᵥ^{th2} is another threshold in a value range of εᵥ, and εᵤᵥ^{th2} may be expressed as follows:

$${ε}_{uv}^{th 2} = \sqrt{\frac{8 ln \frac{1.25}{δ} {min}_{u ∈ N ( v )} {\vert {h}_{uv} \vert}^{2} {P}_{u}}{{\sum }_{u ∈ N ( v )} {\vert {h}_{uv} \vert}^{2} {P}_{u} + {σ}_{v}^{2} - \vert N \vert {min}_{u ∈ N ( v )} {\vert {h}_{uv} \vert}^{2} {P}_{u}}} .$$

In addition, it may be obtained that the power control parameter βᵤᵥ that meets the foregoing constraint condition meets the following formula:

$${β}_{uv} = \{ \begin{matrix}1 - {α}_{uv} , & {ε}_{v} \leq {ε}_{uv}^{th 2} \\ {β}_{uv}^{′} , & {ε}_{uv}^{th 2} < {ε}_{v} \leq {ε}_{uv}^{th 1} \\ 0 , & {ε}_{v} > {ε}_{uv}^{th 1}\end{matrix} \qquad Formula ( 4 )$$

$${ε}_{uv}^{th 1} = \sqrt{\frac{8 ln \frac{1.25}{δ} {min}_{u ∈ N ( v )} {\vert {h}_{uv} \vert}^{2} {P}_{u}}{{σ}_{v}^{2}}} ,$$

and βᵤᵥ′ is obtained by solving a problem by using a quasi-water-filling method, and the problem solved by using the quasi-water-filling method may be represented as:

$$\{ \begin{matrix}1 - \frac{{min}_{u ∈ N ( v )} {\vert {h}_{uv} \vert}^{2} {P}_{u}}{{\vert {h}_{uv} \vert}^{2} {P}_{u}} {=}^{△} {β}_{uv}^{U} \\ 0 \leq {β}_{uv} \leq {β}_{uv}^{U} \\ {\sum }_{u ∈ N ( v )} {\vert {h}_{uv} \vert}^{2} {β}_{uv} {P}_{u} = \frac{8 ln \frac{1.25}{δ} {min}_{u ∈ N ( v )} {\vert {h}_{uv} \vert}^{2} {P}_{u}}{{ε}_{v}^{2}} - {σ}_{v}^{2}\end{matrix} , where \\ 1 - \frac{{min}_{u ∈ N ( v )} {\vert {h}_{uv} \vert}^{2} {P}_{u}}{{\vert {h}_{uv} \vert}^{2} {P}_{u}} {=}^{△} {β}_{uv}^{U}$$

represents that

$$1 - \frac{{min}_{u ∈ N ( v )} {\vert {h}_{uv} \vert}^{2} {P}_{u}}{{\vert {h}_{uv} \vert}^{2} {P}_{u}}$$

is defined as βᵤᵥ^{U}, or in other words,

$$1 - \frac{{min}_{u ∈ N ( v )} {\vert {h}_{uv} \vert}^{2} {P}_{u}}{{\vert {h}_{uv} \vert}^{2} {P}_{u}}$$

is represented by βᵤᵥ^{U}, and βᵤᵥ^{U} in an expression including βᵤᵥ^{U} may be replaced with

$$1 - \frac{{min}_{u ∈ N ( v )} {\vert {h}_{uv} \vert}^{2} {P}_{u}}{{\vert {h}_{uv} \vert}^{2} {P}_{u}} .$$

For the foregoing to-be-solved problem, the first node may perform a step of solving by using the quasi-water injection method, to obtain a value βᵤᵥ′ of βᵤᵥ corresponding to εᵤᵥ^{th2}<εᵥ≤εᵤᵥ^{th1}.

### 1. Initialize

$$D = \frac{8 ln \frac{1.25}{δ} {min}_{u ∈ N ( v )} {\vert {h}_{uv} \vert}^{2} {P}_{u}}{{ε}_{v}^{2}} - {σ}_{v}^{2}$$

and initialize a set 1=N(v)
2. When D>0, calculate a water injection line

$$\overline{D} = \frac{D}{{N}_{I}} ,$$

where N_{I} represents a quantity of elements in a set I, and determine a water injection policy:

If |hᵤᵥ|²βᵤᵥ^{U}≥D̅, ∀u∈I, set

$${β}_{uv} = \frac{\overline{D}}{{\vert {h}_{uv} \vert}^{2} {P}_{u}} , ∀ u ∈ I$$

and update D=0, where ∀u∈I represents that any u belongs to the set I;
otherwise, set

$${β}_{uv} = {β}_{uv}^{U} {𝕀}_{{\vert {h}_{uv} \vert}^{2} {β}_{uv}^{U} {P}_{u} \leq \overline{D}} , ∀ u ∈ I ,$$

where

[symbol] _{A} is an indication function, indicating that if A is true, [symbol] _{A}=1; or if A is false, [symbol] _{A}=0.

$${𝕀}_{{\vert {h}_{uv} \vert}^{2} {β}_{uv}^{U} {P}_{u} \leq \overline{D}}$$

in the foregoing formula represents that:

$$when {\vert {h}_{uv} \vert}^{2} {β}_{uv}^{U} {P}_{u} \leq \overline{D} , {{\vert {h}_{uv} \vert}^{2} {β}_{uv}^{U} {P}_{u} \leq \overline{D}}_{} = 1 ; or when {\vert {h}_{uv} \vert}^{2} {β}_{uv}^{U} {P}_{u} > \overline{D} , \\ {{\vert {h}_{uv} \vert}^{2} {β}_{uv}^{U} {P}_{u} \leq \overline{D}}_{} = 0.$$

In addition, update:

$$D = D - {\sum }_{u ∈ I} {\vert {h}_{uv} \vert}^{2} {β}_{uv}^{U} {P}_{u} {{\vert {h}_{uv} \vert}^{2} {β}_{uv}^{U} {P}_{u} \leq \overline{D}}_{} ,$$

and
remove u that meets |hᵤᵥ|²βᵤᵥ^{U}Pᵤ≤D̅ from the set I.

The first node may obtain the channel information hᵤᵥ between the first node and each second node through channel measurement. For example, there are N second nodes, and identifiers of the N second nodes are respectively 1 to N. The first node may measure a channel between the first node and a second node whose identifier is u=1 to obtain the channel information h₁ᵥ. The first node may measure channel information h₂ᵥ between the first node and a second node whose identifier is u=2, and measure channel information between the first node and another second node, for example, the first node may measure channel information h_{Nv} between the first node and a second node whose identifier is u=N. It should be noted that, a sequence in which the first node measures the channel information between the first node and the plurality of second nodes is not limited in embodiments of this application.

The first node may separately obtain, based on a value interval to which a value of the information security threshold εᵥ belongs, the maximum transmit power Pᵤ of each second node, and the channel information between the first node and each second node (for example, including a channel weighting coefficient hᵤᵥ and a channel noise power σᵥ²), a power control parameter αᵤᵥ and a power control parameter βᵤᵥ that correspond to each second node. The first node sends the power control information to each second node, to notify each second node of the power control parameter corresponding to the second node.

S302: The first node sends the first power control information to the second node, where the first power control information is used by the second node to generate a first signal.

Correspondingly, the second node receives the first power control information from the first node. The second node determines, based on the first power control information, a power control parameter for generating the first signal, where the first signal is a signal sent by the second node to the first node.

The following provides an example of an indication manner in which the first power control information indicates the power control parameter αᵤᵥ and the power control parameter βᵤᵥ. It should be understood that, the indication manner of the first power control information is not limited in this application. It may be understood that, the “indication” in this application includes a direct indication, an indirect indication, an explicit indication, and an implicit indication.

In an example, the first power control information may indicate the power control parameter αᵤᵥ and the power control parameter βᵤᵥ. Alternatively, the first power control information may indicate one of the two power control parameters, and the second node may determine the other power control parameter based on the one power control parameter and a relationship between αᵤᵥ and βᵤᵥ (that is, a sum of the two power control parameters is 1).

In another example, the first power control information may indicate a ratio of αᵤᵥ to βᵤᵥ, and the second node may determine the two power control parameters based on a relationship between αᵤᵥ and βᵤᵥ.

In still another example, the first power control information indicates an identifier of a power control parameter. For example, the first node determines, based on the power control parameter, the identifier corresponding to the power control parameter in a predefined power control parameter set, and notifies the second node by using the first power control information. The second node determines, based on the identifier of the power control parameter indicated by the first power control information, the power control parameter corresponding to the identifier in the predefined power control parameter set. The first power control information may indicate an identifier corresponding to one power control parameter in αᵤᵥ and βᵤᵥ, and the second node determines the other power control parameter based on the relationship between αᵤᵥ and βᵤᵥ. Alternatively, the first power control information may indicate identifiers of the two power control parameters, and the second node determines the two power control parameters based on the identifiers.

S303: The second node sends the first signal to the first node, where the first signal includes data information and first security protection information, and the first security protection information is used to protect information security of the data information.

After determining the power control parameters αᵤᵥ and βᵤᵥ based on the first power control information, the second node may generate the first signal \tilde{w}ᵤᵥ, where the first signal includes the data information wᵤᵥ and the security protection information mᵤᵥ. The first signal \tilde{w}ᵤᵥ may be represented as follows:

$${\tilde{w}}_{uv} = \frac{\sqrt{{α}_{uv} {P}_{u}}}{L} {w}_{uv} + \sqrt{{β}_{uv} {P}_{u}} {m}_{uv} .$$

Alternatively, the second node may perform pre-equalization processing on the signal, and the first signal \tilde{w}ᵤᵥ may be represented as follows:

$${\tilde{w}}_{uv} = {e}^{- j {ϕ}_{uv}} ( \frac{\sqrt{{α}_{uv} {P}_{u}}}{L} {w}_{uv} + \sqrt{{β}_{uv} {P}_{u}} {m}_{uv} ) .$$

An equalization coefficient e^{-jϕ}^{ᵢₙ} may be indicated by the first node to the second node. Alternatively, the equalization coefficient e^{-jϕ}^{ᵢₙ} may be determined after the second node performs channel estimation. For example, if channels in different transmission directions between the first node and the second node are reciprocal, the second node may obtain the equalization coefficient after performing channel estimation. However, this application is not limited thereto.

Correspondingly, the first node receives the first signal from the second node.

In an implementation, the first node receives a first signal from the second node, the first node receives the first signal to obtain a received signal Rᵤᵥ, and the first node may obtain wᵤᵥ in the received signal Rᵤᵥ through decoding.

In another implementation, there are a plurality of second nodes. The first node receives a superimposed signal of first signals from the plurality of second nodes, to obtain a received signal Rᵥ, and obtains wᵥ in the received signal through decoding, where wᵥ is superimposed data information

$${w}_{v} = {\sum }_{u ∈ N ( v )} {w}_{u v}$$

or wᵥ is average value information

$${w}_{v} = E ( {\sum }_{u ∈ N ( v )} {w}_{u v} )$$

of data information of the plurality of second nodes.

According to the foregoing solution, security of the data information transmitted over a wireless channel can be improved, a probability of information leakage can be reduced, and the signal-to-noise ratio of the received signal can be maximized when the security protection requirement of the data information is met, improving the transmission reliability of the data information.

The foregoing describes the graph neural network GNN. In this application, the GNN may be applied to a wireless communication network. By using the GNN, each communication node can obtain features and dependencies of its adjacent nodes of different depths in its environment. In this way, a status feature of the communication node is determined, higher-quality communication may be implemented, and distributed control and scheduling of a network may be implemented.

Each of the plurality of communication nodes that participate in GNN inference may be used as an adjacent node (denoted as a node u) of another node (denoted as a node v), the intermediate result qᵤ^{(k-1)} obtained at the previous layer (for example, a (k−1)^{th} layer) and the feature eᵤᵥ of the edge of the node and the node v are input into the k^{th} layer of the first machine learning model, to obtain the node feature information ƒₜ^{(k)}({qᵤ^{(k-1)},eᵤᵥ} output by the k^{th} layer, and send the node feature information to the node v. In addition, each node further serves as the node v to receive the node feature information ƒₜ^{(k)}{qᵤ^{(k-1)},eᵤᵥ} sent by each adjacent node of the node v, to obtain the intermediate result corresponding to the k^{th} layer of the model, that is, the aggregation feature information

$${q}_{v}^{( k )} = {\sum }_{u ∈ N ( v )} {f}_{t}^{( k )} ( \{ {q}_{u}^{( k - 1 )} , {e}_{u v} \} )$$

of the adjacent node. Then, the node v inputs the intermediate results qᵤ^{(k-1)} and qᵥ^{(k)} obtained at the (k−1)^{th} layer into the k^{th} layer of the second machine learning model, to obtain the output result oᵥ^{(k)}=ƒₒ^{(k)}(qᵥ^{(k-1)},qᵥ^{(k)}) of the k^{th} layer. It can be learned that the node feature information obtained by the node u through each layer iteration needs to be transmitted over a wireless channel, and two consecutive communications are highly correlated. The information security protection method shown in FIG. 3 may be used to improve information transmission security and reliability.

FIG. 4 is a schematic flowchart of a communication method 400 according to an embodiment of this application. It should be noted that, for a part that is in the embodiment shown in FIG. 4 and that is the same as that in the embodiment shown in FIG. 3, refer to the descriptions in FIG. 3. For brevity, details are not described herein again. In the embodiment shown in FIG. 4, a node u (that is, an example of a second node) is an adjacent node of a node v (that is, an example of a first node). The node v may have one or more adjacent nodes, that is, one or more nodes u. The communication method includes but is not limited to the following steps.

S401: The node u broadcasts a maximum transmit power Pᵤ.

In an initialization process, each node broadcasts a maximum transmit power, and receives a maximum transmit power broadcast by an adjacent node. The node v receives the maximum transmit power Pᵤ of each node u, where u∈N(v), and N(v) is a set of identifiers of adjacent nodes of the node. After obtaining the maximum transmit power of the adjacent node in the initialization process, each node performs inference at each layer of a machine learning model. The following S402 to S409 show an inference process at a k^{th} layer.

S402: The node v obtains channel information from each node u to the node v.

For inference at the k^{th} layer, the node v may obtain channel information hᵤᵥ^{(k)} between the node v and each node u through channel measurement. For example, there are N nodes u, and identifiers of the N nodes u are respectively 1 to N. The node y may measure a channel between the node v and a node u whose identifier is u=1, to obtain channel information h₁ᵥ^{(k)} corresponding to inference at the k^{th} layer. The node v may measure a channel between the node v and a node u whose identifier is u=2, to obtain channel information h₂ᵥ^{(k)} corresponding to inference at the k^{th} layer, and measures channel information between the node v and another node u. For example, the node v may measure a channel between the node v and a node u whose identifier is u=N, to obtain channel information h_{Nv}^{(k)} corresponding to inference at the k^{th} layer. It should be noted that, a sequence in which the node v measures the channel information between the node v and the plurality of nodes u is not limited in embodiments of this application. The channel information corresponding to inference at the k^{th} layer of the node v and each node u may be represented as

$${h}_{uv}^{( k )} = \vert {h}_{uv}^{( k )} \vert {e}^{j {ϕ}_{uv}^{( k )}} ,$$

where |hᵤᵥ^{(k)}| represents an amplitude of the channel information hᵤᵥ^{(k)}, and ϕᵤᵥ^{(k)} represents a phase of the channel information hᵤᵥ^{(k)}.

S403: The node v obtains power control information corresponding to the node u based on an information security threshold, a maximum transmit power of the node u, and channel information between the node u and the node v.

The power control information corresponding to the node u is used by the node u to generate a first signal.

In an implementation, there is one or more nodes u, and the node v separately receives a first signal from the node u in S407. In this case, the node v may obtain the power control information corresponding to the node u based on the information security threshold εᵥ, the maximum transmit power Pᵤ of one node, and the channel information between the node u and the node v.

The power control information may be used to indicate a power control parameter αᵤᵥ^{(k)} and/or a power control parameter Bᵤᵥ^{(k)}, where αᵤᵥ^{(k)} is a power control parameter of the data information of the node u, and βᵤᵥ^{(k)} is a power control parameter of the security protection information of the node u. For a manner in which the node v obtains the power control parameter αᵤᵥ^{(k)} and/or the power control parameter βᵤᵥ^{(k)} that correspond to the node u, refer to Implementation 1 in the embodiment shown in FIG. 3. For example, the node v determines, based on Pᵤ, the information security threshold εᵥ, and hᵤᵥ^{(k)}, the power control parameter αᵤᵥ^{(k)} according to Formula (1) and determines the power control parameter βᵤᵥ^{(k)} according to Formula (2). Therefore, the node v may determine power control information that corresponds to the node u and that indicates the power control parameters αᵤᵥ^{(k)} and/or βᵤᵥ^{(k)} The node y may determine, in this manner, the power control parameters αᵤᵥ^{(k)} and/or βᵤᵥ^{(k)} that correspond to each node u and corresponding power control information.

In another implementation, there are a plurality of nodes u, and the node v receives a superimposed signal of first signals from the plurality of nodes u in S407. In this case, the node v obtains, based on an information security threshold εᵥ, a maximum transmit power of the plurality of nodes u, and channel information between the plurality of nodes u and the node v, power control information corresponding to each node u.

For a manner in which the node v obtains the power control parameters αᵤᵥ^{(k)} and αᵤᵥ^{(k)} corresponding to the node u, refer to Implementation 2 in the embodiment shown in FIG. 3. For example, the node v determines, based on εᵥ, Pᵤ of one node u, and channel information hᵤᵥ^{(k)} between the plurality of u and the node v, a power control parameter αᵤᵥ^{(k)} corresponding to the node u according to Formula (3) and a power control parameter βᵤᵥ^{(k)} according to Formula (4). Therefore, the node v may determine αᵤᵥ^{(k)} and βᵤᵥ^{(k)} that indicate the power control parameter and corresponding power control information.

S404: The node v sends the power control information to each node u.

The node y notifies, by using the power control information, the power control parameter corresponding to each node u. For a specific implementation in which the power control information indicates the power control parameter, refer to the foregoing descriptions. For brevity, details are not described herein again.

Optionally, the node y may send first information to each node u, and the first information is used to request node feature information output by a k^{th} layer of a first machine learning model. In this way, after receiving the first information, each node u sends, to the node v, the node feature information that is output by the k^{th} layer of the first machine learning model and that is obtained by each node u.

The node y may separately send the power control information and the first information to each node. Alternatively, the first information may include the power control information. Alternatively, the power control information may be used as the first information to request the node feature information output by the k^{th} layer of the first machine learning model. After receiving the power control information, the node u sends corresponding node feature information to the node v.

S405: The node u inputs second feature information into the k^{th} layer of the first machine learning model, to obtain the node feature information output by the k^{th} layer of the first machine learning model.

The second feature information is denoted as qᵤ^{(k-1)}. If k=1, the second feature information qᵤ^{(k-1)} is node feature information xᵤ of the node u, that is, qᵤ⁽⁰⁾=xᵤ, and the node feature information output by the k^{th} layer of the first machine learning model is ƒₜ⁽¹⁾({xᵤ,eᵤᵥ}).

If k is an integer greater than 1, the second feature information qᵤ^{(k-1)} is adjacent node feature information that corresponds to a (k−1)^{th} layer of the first machine learning model and that is obtained by the node u. For the adjacent node feature information qᵤ^{(k-1)} that corresponds to the (k−1)^{th} layer of the first machine learning model, refer to the following implementation of qᵥ^{(k)} determined by the node v in S408.

For example, the k^{th} layer of the first machine learning model may be represented as a function ƒₜ^{(k)}, and the second feature information qᵤ^{(k-1)} is input into the k^{th} layer of the first machine learning model, to obtain the node feature information ƒₜ^{(k)}{qᵤ^{(k-1)},eᵤᵥ} output by the k^{th} layer of the first machine learning model, where eᵤᵥ is feature information of an edge of the node u and the node v.

S406: The node u generates the first signal based on the power control information, where the first signal includes the node feature information output by the k^{th} layer of the first machine learning model and security protection information.

The node u may need to superimpose the security protection information mᵤᵥ on the node feature information ƒₜ(k)({qᵤ^{(k-1)},eᵤᵥ}. The security protection information mᵤᵥ may be white Gaussian noise. However, this is not limited in this application. The node u may determine the power control parameters αᵤᵥ^{(k)} and βᵤᵥ^{(k)} based on the power control information, to generate the first signal based on the power control parameters αᵤᵥ^{(k)} and βᵤᵥ^{(k)}, the node feature information ƒₜ^{(k)}({qᵤ^{(k-1)},eᵤᵥ}, and the security protection information mᵤᵥ.

In an example, the first signal may be represented as:

$${\tilde{w}}_{uv}^{( k )} = {e}^{- j {ϕ}_{uv}} ( \frac{\sqrt{{α}_{uv} {P}_{u}}}{L} {f}_{t}^{( k )} ( \{ {q}_{u}^{( k - 1 )} , {e}_{u v} \} + \sqrt{{β}_{uv} {P}_{u}} {m}_{uv} ) .$$

L is an upper limit of a norm ∥\tilde{w}ᵤᵥ^{(k)}∥₂ of the data information \tilde{w}ᵤᵥ^{(k)}, that is, ∥\tilde{w}ᵤᵥ^{(k)}∥₂≤L, and e^{-jϕ}^{ᵤᵥ} is an equalization coefficient. The equalization coefficient may be sent by the node v to the node u. For example, the first information may include the equalization coefficient, or when channels are reciprocal, the node u may obtain the equalization coefficient after performing channel estimation. This is not limited in this application.

In another example, if the node v receives the first signal from each node u in S407, the node u may not perform pre-equalization processing, and the first signal may be represented as:

$${\tilde{w}}_{uv}^{( k )} = \frac{\sqrt{{α}_{uv} {P}_{u}}}{L} {f}_{t}^{( k )} ( \{ {q}_{u}^{( k - 1 )} , {e}_{u v} \} + \sqrt{{β}_{uv} {P}_{u}} {m}_{uv} .$$

According to the foregoing solution, the node u performs power control on the to-be-sent node feature information and the security protection information based on the power control information, so that security of the data information transmitted over a wireless channel can be improved, a probability of information leakage can be reduced, and a signal-to-noise ratio of a received signal can be maximized when the security protection requirement of data information is met, improving the transmission reliability of the data information.

S407: Each node u sends the first signal to the node v.

The node v receives the first signal from each node u.

In an implementation, there are a plurality of nodes u, and the node v receives a superimposed signal of first signals from the plurality of nodes u, to obtain a received signal Rᵥ^{(k)}.

For example, the plurality of nodes u simultaneously send respective first signals, so that the first signals of the plurality of nodes u are superimposed on a channel, and the node v receives and obtains the received signal Rᵥ^{(k)}. For example, the received signal Rᵥ^{(k)} may be represented as:

$${R}_{v}^{( k )} = {\sum }_{u ∈ N ( v )} ( {h}_{uv} {\tilde{w}}_{uv}^{( k )} + {n}_{uv}^{( k )} ) = {\sum }_{u ∈ N ( v )} \vert {h}_{uv}^{( k )} \vert \frac{\sqrt{{α}_{uv}^{( k )} {P}_{u}}}{L} {f}_{t}^{( k )} ( \{ {q}_{u}^{( k - 1 )} , {e}_{u v} \} ) + {\sum }_{u ∈ N ( v )} \vert {h}_{uv}^{( k )} \vert \sqrt{{β}_{uv}^{( k )} {P}_{u}} {m}_{uv}^{( k )} + {n}_{v}^{( k )} .$$

nᵥ^{(k)} includes channel noise of a channel between the plurality of nodes u and the node v,

$${n}_{v}^{( k )} = {\sum }_{u ∈ N ( v )} {n}_{u v}^{( k )} ,$$

and nᵤᵥ^{(k)} is channel noise of a channel between the node u and the node v.

For example, there are N second nodes, and a set of identifiers of the second nodes includes N identifiers corresponding to the N second nodes. For example, if the identifiers of the N second nodes are respectively 1 to N, the first node receives a superimposed signal of first signals of the N second nodes, and an obtained received signal Rᵥ^{(k)} may be represented as:

$${R}_{v}^{( k )} = {\sum }_{u ∈ N ( v )} ( {h}_{uv}^{( k )} {\tilde{w}}_{uv}^{( k )} + {n}_{uv}^{( k )} ) = ( {h}_{1 v}^{( k )} {\tilde{w}}_{1 v}^{( k )} + {n}_{1 v}^{( k )} ) + ( {h}_{2 v}^{( k )} {\tilde{w}}_{2 v}^{( k )} + {n}_{2 v}^{( k )} ) + … + ( {h}_{Nv}^{( k )} {\tilde{w}}_{Nv}^{( k )} + {n}_{Nv}^{( k )} ) = {\sum }_{u ∈ N ( v )} \vert {h}_{uv}^{( k )} \vert \frac{\sqrt{{α}_{uv}^{( k )} {P}_{u}}}{L} {f}_{t}^{( k )} ( \{ {q}_{u}^{( k - 1 )} , {e}_{uv} \} ) + {\sum }_{u ∈ N ( v )} \vert {h}_{uv}^{( k )} \vert \sqrt{{β}_{uv}^{( k )} {P}_{u}} {m}_{uv}^{( k )} + {n}_{v}^{( k )} .$$

h₁ᵥ^{(k)} is channel information corresponding to inference at the k^{th} layer between a second node whose identifier is 1 and the first node, h₂ᵥ^{(k)} is channel information corresponding to inference at the k^{th} layer between a second node whose identifier is 2 and the first node, and h_{Nv}^{(k)} is channel information corresponding to inference at the k^{th} layer between a second node whose identifier is N and the first node.

In another implementation, the node v separately receives a first signal of each node u, to obtain a received signal Rᵤᵥ corresponding to each node u. For example, the received signal Rᵤᵥ may be represented as:

$${R}_{uv}^{( k )} = {h}_{uv}^{( k )} {\tilde{w}}_{uv}^{( k )} + {n}_{uv}^{( k )} ,$$

where,

nᵤᵥ^{(k)} is channel noise of a channel between the node u and the node v.

S408: The node v estimates, based on the received signal obtained by receiving the first signal, adjacent node feature information corresponding to the k^{th} layer of the first machine learning model.

For example, the received signal is a superimposed signal Rᵥ received by the first node after the first signals of the plurality of nodes u are superimposed on the channel, or if the plurality of nodes u are included, the node v separately receives first information of each node u, and after obtaining a received signal Rᵤᵥ corresponding to each node u, the node v performs superimposition processing on the received signal Rᵤᵥ corresponding to the plurality of nodes u, to obtain the superimposed signal Rᵥ, that is,

$${R}_{v}^{( k )} = {\sum }_{u ∈ N ( v )} ( {h}_{uv}^{( k )} {\tilde{w}}_{uv}^{( k )} + {n}_{uv}^{( k )} ) .$$

The node v obtains, through estimation based on the superimposed signal Rᵥ, the adjacent node feature information qᵥ^{(k)} corresponding to the k^{th} layer of the first machine learning model, where qᵥ^{(k)} is an average value of a superimposed signal of node feature information ƒₜ^{(k)}({qᵤ^{(k-1)},eᵤᵥ} that is output by the k^{th} layer of the first machine learning model and that is from each node u, that is:

$${q}_{v}^{( k )} = E [ {\sum }_{u ∈ N ( v )} {f}_{t}^{( k )} ( \{ {q}_{u}^{( k - 1 )} , {e}_{uv} \} ) ] ,$$

where
E[x] represents an average value of x.

For another example, the node v separately receives a first signal of each node, to obtain a received signal Rᵤᵥ corresponding to each node u. The node v may obtain, through estimation based on each received signal Rᵤᵥ, node feature information that ƒₜ^{(k)}({qᵤ^{(k-1)},eᵤᵥ} that is output by the k^{th} layer of the first machine learning model on a corresponding node u. The node v obtains an average value qᵥ^{(k)} of a superimposed signal of all node feature information ƒₜ^{(k)}({qᵤ^{(k-1)},eᵤᵥ}. For details, refer to the foregoing expression.

S409: The node v inputs the first feature information and the adjacent node feature information corresponding to the k^{th} layer of the first machine learning model into a k^{th} layer of a second machine learning model, to obtain aggregation node feature information output by the k^{th} layer of the second machine learning model.

For example, the k^{th} layer of the second machine learning model may be represented as a function ƒₒ^{(k)}, and the node v inputs the first feature information qᵥ^{(k-1)} and the adjacent node feature information qᵥ^{(k)} corresponding to the k^{th} layer of the first machine learning model into the k^{th} layer of the second machine learning model, to obtain the aggregation node feature information oᵥ^{(k)} output by the k^{th} layer of the second machine learning model, that is:

$${o}_{v}^{( k )} = {f}_{o}^{( k )} ( {q}_{v}^{( k - 1 )} , {q}_{v}^{( k )} ) .$$

If k=1, qᵥ^{(k-1)} is the node feature information xᵥ of the node v, that is, qᵥ⁽⁰⁾=xᵥ, and the aggregation node feature information is oᵥ^{(k)}=ƒₒ^{(k)}(xᵥ,qᵥ^{(k)}).

If k is an integer greater than 1, qᵤ^{(k-1)} is aggregation node feature information that is output by a (k−1)^{th} layer of the second machine learning model and that is obtained by the node v.

Each of a plurality of communication nodes that participate in GNN inference is used as the node u in inference at the k^{th} layer, to infer ƒₜ^{(k)}({qᵤ^{(k-1)},eᵤᵥ}, the first signal is generated based on the power control information from each adjacent node (that is, the node v), and the first signal is sent to a corresponding adjacent node. In addition, each communication node further serves as the node v to obtain the power control information of each adjacent node (that is, the node) through prediction and notify each adjacent node, and then receives the first signal that is obtained through processing on the power control information from each adjacent node and that includes the security protection information, to obtain the adjacent node feature information qᵥ^{(k)} corresponding to the k^{th} layer of the first machine learning model, input the adjacent node feature information into the k^{th} layer of the second machine learning model, and obtain the output result of the k^{th} layer of the GNN through inference. Each node then performs inference at a (k+1)^{th} layer of the GNN. For details, refer to the procedures of S402 to S409. For brevity, details are not described herein again. Each communication node may complete an inference process through inference at K layers of the GNN, and each communication node obtains a GNN inference result including an output result of each of the K layers. K is a positive integer, and may be determined based on a specific implementation. This is not limited in this application.

It should be noted that, each node may exchange, based on an information security protection requirement, power control information at a GNN inference layer at which information security protection needs to be performed, and generate, based on the power control information, a signal including security protection information. At a GNN inference layer at which information security protection does not need to be performed, the power control information may not need to be exchanged, and a to-be-sent signal including node feature information may not include the security protection information. This may be implemented based on a specific implementation requirement. This is not limited in this application.

The GNN is applied to a wireless communication network, so that each communication node can obtain features and dependencies of its adjacent nodes of different depths in its environment. In this way, a status feature of the communication node is determined, higher-quality communication may be implemented, and distributed control and scheduling of a network may be implemented. In a GNN inference process, information security protection is performed and transmit power control is performed by adding noise at a transmit end, so that information security and information transmission reliability in the inference process can be improved.

To implement GNN inference in the wireless network, and obtain expected inference performance, the first machine learning model and the second machine learning model need to match a wireless network environment in a training process. A data processing node in a network may train data to perform model training. The data processing node may be a core network node, a server, an OAM, or the like. However, this application is not limited thereto. The training data may be obtained by collecting data of a communication node in a wireless network. The training data includes node feature information (that is, node data), association data between adjacent nodes (that is, edge data, for example, channel information between adjacent nodes), channel information used for security protection, a maximum transmit power of a node, and security requirement data. The communication node may include but is not limited to a terminal and/or a wireless access network node.

After the training data is collected, the data processing node may perform data preprocessing, and perform a training process of the GNN model (including the first machine learning model and the second machine learning model) based on the preprocessed training data. In this process, each model training includes iterative forward propagation and backward gradient updates. In a forward propagation process, a wireless channel environment, information security protection, and power control need to be simulated. Specifically, for the forward propagation process, refer to the inference process in the embodiment shown in FIG. 4. After each forward propagation, a gradient is updated, a model parameter is adjusted, and then next model training is performed until a GNN model parameter converges to a value less than a preset threshold, to obtain a trained GNN model, that is, the first machine learning model and the second machine learning model. In this way, the GNN model can be applied to a wireless network, and the expected inference performance is obtained.

The foregoing describes in detail the method provided in this application with reference to the accompanying drawings. The following accompanying drawings describe a communication apparatus and a communication device provided this application. To implement functions in the methods provided in this application, network elements may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

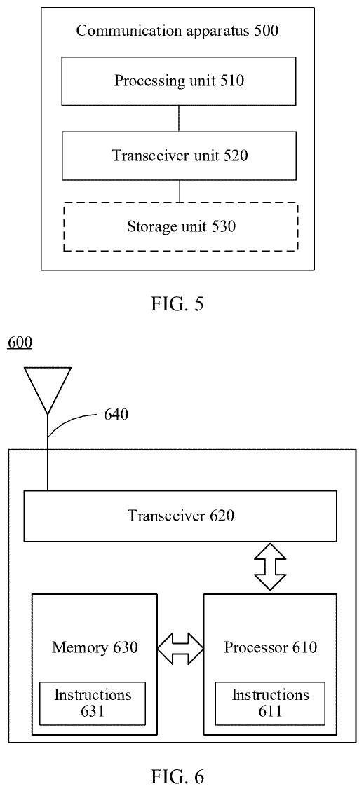

FIG. 5 is a block diagram of a communication apparatus according to this application. As shown in FIG. 5, the communication apparatus 500 may include a transceiver unit 520.

In a possible design, the communication apparatus 500 may correspond to the first node in the foregoing method. When the communication apparatus 500 corresponds to the first node, the communication apparatus 500 may be a communication device, or the communication apparatus 500 may be a chip configured in (or used in) a communication device, or another apparatus, module, circuit, unit, or the like that can implement a method of the first node.

It should be understood that, the communication apparatus 500 may include units configured to perform the method performed by the first node in the foregoing method embodiments. In addition, the units in the communication apparatus 500 and the foregoing other operations and/or functions are separately used to implement corresponding procedures in the foregoing method embodiments.

Optionally, the communication apparatus 500 may further include a processing unit 510. The processing unit 510 may be configured to process instructions or data, to implement a corresponding operation.

It should be further understood that, when the communication apparatus 500 is a chip configured in (or used in) the first node, the transceiver unit 520 in the communication apparatus 500 may be an input/output interface or a circuit of the chip, and the processing unit 510 in the communication apparatus 500 may be a processor in the chip.

Optionally, the communication apparatus 500 may further include a storage unit 530. The storage unit 530 may be configured to store instructions or data. The processing unit 510 may execute the instructions or the data stored in the storage unit, so that the communication apparatus is enabled to implement a corresponding operation.

It should be further understood that, a specific process in which each unit performs the foregoing corresponding steps has been described in detail in the foregoing methods. For brevity, details are not described herein again.

In another possible design, the communication apparatus 500 may correspond to the second node in the foregoing method. When the communication apparatus 500 corresponds to the second node, the communication apparatus 500 may be a communication device, or the communication apparatus 500 may be a chip configured in (or used in) a communication device, or another apparatus, module, circuit, unit, or the like that can implement a method of the second node.

It should be understood that, the communication apparatus 500 may include units configured to perform the method performed by the second node in the foregoing method embodiments. In addition, the units in the communication apparatus 500 and the foregoing other operations and/or functions are separately used to implement corresponding procedures in the foregoing method embodiments.

Optionally, the communication apparatus 500 may further include a processing unit 510. The processing unit 510 may be configured to process instructions or data, to implement a corresponding operation.

It should be further understood that, when the communication apparatus 500 is a chip configured in (or used in) the second node, the transceiver unit 520 in the communication apparatus 500 may be an input/output interface or a circuit of the chip, and the processing unit 510 in the communication apparatus 500 may be a processor in the chip.

Optionally, the communication apparatus 500 may further include a storage unit 530. The storage unit 530 may be configured to store instructions or data. The processing unit 510 may execute the instructions or the data stored in the storage unit, so that the communication apparatus is enabled to implement a corresponding operation.

It should be understood that, the transceiver unit 520 in the communication apparatus 500 may be implemented by using a communication interface (for example, a transceiver, a transceiver circuit, an input/output interface, a pin, or the like), for example, may correspond to a transceiver 620 in a communication apparatus 600 shown in FIG. 6. The processing unit 510 in the communication apparatus 500 may be implemented by using at least one processor, for example, may correspond to a processor 610 in the communication apparatus 600 shown in FIG. 6. The processing unit 510 in the communication apparatus 500 may be further implemented by using at least one logic circuit. The storage unit 530 in the communication apparatus 500 may correspond to a memory 630 in the communication apparatus 600 shown in FIG. 6.

FIG. 6 is a diagram of a structure of a communication apparatus 600 according to an embodiment of this application. As shown in FIG. 6, the communication apparatus 600 includes one or more processors 610. The processor 610 may be configured to perform internal processing of the apparatus, to implement a specific control processing function. Optionally, the processor 610 includes instructions 611. Optionally, the processor 610 may store data.

Optionally, the communication apparatus 600 includes one or more memories 630, configured to store instructions 631. Optionally, the memory 630 may further store data. The processor and the memory may be separately disposed, or may be integrated together.

Optionally, the communication apparatus 600 may further include a transceiver 620 and/or an antenna 640. The transceiver 620 may be configured to send information to another apparatus or receive information from another apparatus. The transceiver 620 may be referred to as a transceiver, a transceiver circuit, an input/output interface, or the like, and is configured to implement a transceiver function of the communication apparatus 600 by using the antenna 640. Optionally, the transceiver 620 includes a transmitter and a receiver.

The communication apparatus 600 may be used in the communication device in the system shown in FIG. 1. The communication apparatus 600 may correspond to the first node or the second node. The communication apparatus 600 may be a communication device. Alternatively, the communication apparatus 600 is configured in a communication device. For example, the communication apparatus 600 may be a chip or a module configured in the communication device. The communication apparatus 600 may perform operations of the first node or the second node in the foregoing method embodiments.

In this application, the processor may be a general-purpose processor, a digital signal processor, an application-specific integrated circuit, a field programmable gate array or another programmable logic device, a discrete gate or a transistor logic device, or a discrete hardware component, and may implement or perform the methods, steps, and logical block diagrams in this application. The general-purpose processor may be a microprocessor or any conventional processor or the like. The steps of the methods with reference to this application may be directly performed and completed by a hardware processor, or may be performed and completed by a combination of hardware and software modules in the processor.

In this application, the memory may be a non-volatile memory, such as a hard disk drive (HDD) or a solid-state drive (SSD), or may be a volatile memory, such as a random access memory (RAM). The memory is any other medium that can carry or store expected program code in a form of instructions or a data structure and that can be accessed by a computer, but is not limited thereto. The memory in this application may alternatively be a circuit or any other apparatus that can implement a storage function, and is configured to store program instructions and/or data.

This application further provides a processing apparatus, including a processor and a (communication) interface. The processor is configured to perform the method provided in the foregoing method embodiments.

It should be understood that, the processing apparatus may be one or more chips. For example, the processing apparatus may be a field programmable gate array (FPGA), an application-specific integrated circuit (ASIC), a system on chip (SoC), a central processing unit (CPU), a network processor (NP), a digital signal processing circuit (e.g. a digital signal processor (DSP)), a microcontroller (MCU), a programmable controller (PLD), or another integrated chip.

This application further provides a computer-readable storage medium. The computer-readable storage medium stores a computer program or instructions. When the computer program or the instructions are run, the method performed by the second node or the first node device in the foregoing method embodiments is implemented. In this way, the functions described in the foregoing embodiments may be implemented in a form of a software functional unit and sold or used as an independent product. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a second node, or the like) to perform all or some of the steps of the methods described in embodiments of this application. The storage medium includes: any medium that can store program code, such as a USB flash drive, a removable hard disk drive, a read-only memory (ROM), a random access memory RAM, a magnetic disk, or an optical disc.

According to the method provided in this application, this application further provides a computer program product. The computer program product includes computer program code. When the computer program code is executed by one or more processors, an apparatus including the processor is enabled to perform the methods shown in FIG. 3 and FIG. 4.

All or some of the technical solutions provided in this application may be implemented by using software, hardware, firmware, or any combination thereof. When software is used to implement embodiments, all or some of embodiments may be implemented in a form of a computer program product. The computer program product includes one or more computer instructions. When the computer program instructions are loaded and executed on a computer, the procedure or functions according to this application are all or partially generated. The foregoing computer instructions may be stored in a computer-readable storage medium, or may be transmitted from a computer-readable storage medium to another computer-readable storage medium. The computer-readable storage medium may be any usable medium accessible by a computer, or a data storage device, such as a server or a data center, integrating one or more usable media. The usable medium may be a magnetic medium (for example, a floppy disk, a hard disk drive, or a magnetic tape), an optical medium (for example, a digital video disc (DVD)), a semiconductor medium, or the like.

According to the method provided in this application, this application further provides a system, including the foregoing one or more first node devices. The system may further include the foregoing plurality of second nodes.

In the several embodiments provided in this application, it should be understood that, the disclosed system, apparatus, and method may be implemented in another manner. For example, the described apparatus is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method, wherein the method is applied to a first node and the method comprises:
obtaining first power control information based on an information security protection requirement, a maximum transmit power of a second node, and channel information between the second node and the first node, wherein the first power control information is power control information that is obtained through prediction and that maximizes a signal-to-noise ratio of a received signal of the first node when the information security protection requirement is met, and the received signal comprises a signal from the second node;
sending the first power control information to the second node; and
receiving a first signal from the second node, wherein the first signal is associated with the first power control information, the first signal comprises data information and security protection information, and the security protection information is used to protect information security of the data information.

2. The method according to claim 1, wherein the first power control information comprises power control information corresponding to the data information and power control information corresponding to the security protection information.

3. The method according to claim 1, wherein there are a plurality of second nodes, and wherein the obtaining of the first power control information corresponding to the second node based on the information security budget, the maximum transmit power of the second node, and the channel information between the second node and the first node comprises:
obtaining power control information corresponding to each second node based on the information security protection requirement, the maximum transmit power of each second node, and the channel information between the plurality of second nodes and the first node; and wherein the receiving of the first signal from the second node comprises:
receiving a superimposed signal of first signals from the plurality of second nodes.

4. The method according to claim 1, further comprising:
sending first information to the second node, wherein the first information is used to request node feature information output by a k^{th} layer of a first machine learning model, and the data information comprises the node feature information from the second node; and
determining, based on the node feature information output by the k^{th} layer of the first machine learning model, second node feature information corresponding to the k^{th} layer of the first machine learning model.

5. The method according to claim 4, wherein the first information comprises the first power control information.

6. The method according to claim 4, further comprising:
inputting first feature information and the second node feature information corresponding to the k^{th} layer of the first machine learning model into a k^{th} layer of a second machine learning model, to obtain aggregation node feature information output by the k^{th} layer of the second machine learning model, wherein k is equal to 1, and the first feature information is node feature information of the first node; or k is an integer greater than 1, and the first feature information is second node feature information corresponding to a (k−1)^{th} layer of the first machine learning model.

7. The method according to claim 4, further comprising:
inputting the second node feature information corresponding to the k^{th} layer into a (k+1)^{th} layer of the first machine learning model, to obtain node feature information output by the (k+1)^{th} layer of the first machine learning model;
receiving second power control information from the second node; and
sending a second signal to the second node, wherein the second signal comprises the node feature information output by the (k+1)^{th} layer of the first machine learning model and security protection information, and the second signal is generated based on the second power control information.

8. A method, wherein the method is applied to a second node and the method comprises:
receiving first power control information from a first node; and
sending a first signal to the first node, wherein the first signal is associated with the first power control information, the first signal comprises data information and security protection information, and the security protection information is used to protect information security of the data information.

9. The method according to claim 8, wherein the first power control information comprises power control information corresponding to the data information and power control information corresponding to the security protection information.

10. The method according to claim 8, further comprising:
receiving first information from the first node, wherein the first information is used to request node feature information output by a k^{th} layer of a first machine learning model, the data information comprises the node feature information of the second node, and k is a positive integer.

11. The method according to claim 10, wherein the first information comprises the first power control information.

12. The method according to claim 10, further comprising:
inputting second feature information into the k^{th} layer of the first machine learning model, to obtain the node feature information output by the k^{th} layer of the first machine learning model, wherein k=1, and the second feature information is node feature information of the second node; or k is an integer greater than 1, the second feature information is first node feature information corresponding to a (k−1)^{th} layer of the first machine learning model, and the first node feature information is associated with the node feature information from at least one first node.

13. A communication apparatus, comprising a processor, wherein the processor is coupled to a memory, the memory is configured to store a computer program, and the processor is configured to execute the computer program stored in the memory, to cause the communication apparatus to:
obtain first power control information based on an information security protection requirement, a maximum transmit power of a second node, and channel information between the second node and a first node, wherein the first power control information is power control information that is obtained through prediction and that maximizes a signal-to-noise ratio of a received signal of the first node when the information security protection requirement is met, and the received signal comprises a signal from the second node; and
send the first power control information to the second node,
receive the first signal from the second node, wherein the first signal is associated with the first power control information, and the first signal comprises data information and security protection information, and the security protection information is used to protect information security of the data information.

14. The communication apparatus according to claim 13, wherein the first power control information comprises power control information corresponding to the data information and power control information corresponding to the security protection information.

15. The communication apparatus according to claim 13, wherein there are a plurality of second nodes, and wherein the computer program is executed to further cause the communication apparatus to:
obtain power control information corresponding to each second node based on the information security protection requirement, the maximum transmit power of each second node, and the channel information between the plurality of second nodes and the first node; and
receive a superimposed signal of first signals from the plurality of second nodes.

16. The communication apparatus according to claim 13, wherein the computer program is executed to further cause the communication apparatus to:
send first information to the second node, wherein the first information is used to request node feature information output by a k^{th} layer of a first machine learning model, and the data information comprises the node feature information from the second node; and
determine, based on the node feature information output by the k^{th} layer of the first machine learning model, second node feature information corresponding to the k^{th} layer of the first machine learning model.

17. The communication apparatus according to claim 16, wherein the first information comprises the first power control information.

18. The communication apparatus according to claim 16, wherein the computer program is executed to further cause the communication apparatus to:
input first feature information and the second node feature information corresponding to the k^{th} layer of the first machine learning model into a k^{th} layer of a second machine learning model, to obtain aggregation node feature information output by the k^{th} layer of the second machine learning model, wherein k is equal to 1, and the first feature information is node feature information of the first node; or k is an integer greater than 1, and the first feature information is second node feature information corresponding to a (k−1)^{th} layer of the first machine learning model.

19. The communication apparatus according to claim 16, wherein the computer program is executed to further cause the communication apparatus to:
input the second node feature information corresponding to the k^{th} layer into a (k+1)^{th} layer of the first machine learning model, to obtain node feature information output by the (k+1)^{th} layer of the first machine learning model;
receive second power control information from the second node; and
send a second signal to the second node, wherein the second signal comprises the node feature information output by the (k+1)^{th} layer of the first machine learning model and security protection information, and the second signal is generated based on the second power control information.

20. The communication apparatus according to claim 16, wherein one or more of the first machine learning model and the second machine learning model is associated with a graph neural network (GNN).
